(19) United States
(12) Patent Application Publication
(10) Pub. No.: US 2017/0337028 A1
(43) Pub. Date: Nov. 23, 2017

(54) METHOD AND SYSTEM FOR MODULAR DISPLAY FRAME

(71) Applicant: Qisda Corporation, Taoyuan City (TW)

(72) Inventors: Yu-Fu Fan, Hsinchu City (TW); Ming-Zong Chen, New Taipei City (TW); Yun-Chi Liu, Hsinchu County (TW)

(73) Assignee: Qisda Corporation, Taoyuan City (TW)

(21) Appl. No.: 15/597,241

(22) Filed: May 17, 2017

(30) Foreign Application Priority Data
May 17, 2016 (CN) 201610325719.1
Sep. 26, 2016 (CN) 201610853169.0

(51) Int. Cl. G06F 3/14; G06K 7/14; G06F 3/0346

(52) U.S. Cl. CPC G06F 3/1423; G06F 3/0346; G06K 7/1417

(57) ABSTRACT

A method for modular display frame is provided. The method includes the following steps. A number of display devices are combined to form a composite screen. A directional code including a number of positioning marks is displayed on each display device. The directional code displayed on each display device is scanned. Orientation information of each display device is obtained. A unique pattern is displayed on each display device. The composite screen is captured to generate a first image. Spatial location information of each display device is obtained from the first image. A number of display parameters corresponding to the display devices are calculated according to the orientation information and the spatial location information of the display devices. The display parameters are transmitted to the display devices. Each display device displays a regional frame according to the display parameters of the corresponding display device.

This application claims the benefit of People's Republic of China application Serial No. 201610325719.1, filed May 17, 2016, and People's Republic of China application Serial No. 201610853169.0, filed Sep. 26, 2016, the subject matter of which is incorporated herein by reference.

### BACKGROUND OF THE INVENTION

### Field of the Invention

The invention relates in general to a display method and a display system, and more particularly to a method and system for modular display frame using a number of display devices.

### Description of the Related Art

Along with the booming development in the display technology, the application of modular display frame has become more and more popular. In places, for example, concerts, department stores and markets, large-size TV walls are often used to display product advertisements or performance. Also, in places, for example, art galleries, museums, and exhibition centers, a number of screens can be combined according to an irregular arrangement to express design aesthetics. Therefore, how to design an easy-to-use method and system for modular display frame has become a prominent task in the industry.

### SUMMARY OF THE INVENTION

According to one embodiment of the present invention, a method for modular display frame is provided. The method includes the following steps. A number of display devices are combined to form a composite screen. A directional code including a number of positioning marks is displayed on each of the display devices. The directional code displayed on each of the display devices is scanned. Orientation information of each of the display devices is obtained. A unique pattern is displayed on each of the display devices. The composite screen is captured to generate a first image. Spatial location information of each of the display devices is obtained according to the unique pattern displayed on each of the display devices in the first image. A number of display parameters corresponding to the display devices are calculated according to the orientation information and the spatial location information of the display devices. A number of display parameters are transmitted to the display devices. Each display device displays a regional frame according to the display parameters of the corresponding display device.

According to another embodiment of the present invention, a system for modular display frame is provided. The system includes a number of display devices and an electronic device. The display devices are combined to form a composite screen. During a scanning stage, each of the display devices displays a directional code including a number of positioning marks. During a capturing stage, each of the display devices displays a unique pattern. The electronic device includes an image capturing unit, a processing unit, and a communication unit. During the scanning stage, the image capturing unit scans the directional code displayed on each of the display devices. During the capturing stage, the image capturing unit captures the composite screen to generate a first image. The processing unit obtains orientation information of each of the display devices according to the positioning marks displayed on each of the display devices, obtains spatial location information of each of the display devices according to the unique pattern displayed on each of the display devices in the first image, and calculates a number of display parameters of the corresponding display devices according to the orientation information and the spatial location information of the display devices. The communication unit transmits the display parameters to the display devices, so that each of the display devices displays a regional frame according to the display parameters of the corresponding display device.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a flowchart of a method for modular display frame according to an embodiment of the present invention.

FIG. 2 is a schematic diagram of a system for modular display frame according to an embodiment of the present invention.

FIG. 3 is a schematic diagram of combining a number of display devices to form a composite screen according to an embodiment of the present invention.

FIG. 4 is a schematic diagram of displaying a directional code on each of the display devices according to an embodiment of the present invention.

FIG. 5 is a schematic diagram of a directional code displayed on a display device according to an embodiment of the present invention scanning.

FIG. 6 is a schematic diagram of obtaining orientation information of each of the display devices according to positioning mark according to an embodiment of the present invention.

FIG. 7 is a schematic diagram of displaying a unique pattern on each of the display devices according to an embodiment of the present invention.

FIG. 8 is a schematic diagram of displaying a unique pattern on each of the display devices according to an embodiment of the present invention.

FIG. 9 is a schematic diagram of capturing a composite screen to generate a first image according to an embodiment of the present invention.

FIG. 10 is a schematic diagram of calculating display parameters according to an embodiment of the present invention.

FIG. 11 is a schematic view showing a photographing state of the system for modular display frame according to the embodiment of the invention.

FIG. 12 is the block diagram of a sub-screen according to the embodiment of the invention.

FIG. 13 is a schematic view of a first image in a predetermined coordinate system according to the embodiment of the invention.

FIG. 14 is a schematic view for determining the coordinate and the angel of the first sub-screen in the first image in the predetermined coordinate system according to the embodiment of the invention.

FIG. 15 is a schematic view of the image capturing unit in a predetermined state when capturing the composite screen according to the embodiment of the invention.

FIG. 16 shows the actual photographing state changes with respect to the predetermined state when the image capturing unit photographs the composite screen according to the embodiment of the invention.

FIG. 17 shows a system of modular display frame according to another embodiment of the present invention.

FIG. 18 shows a method for modular display frame according to an embodiment of the present invention.

### DETAILED DESCRIPTION OF THE INVENTION

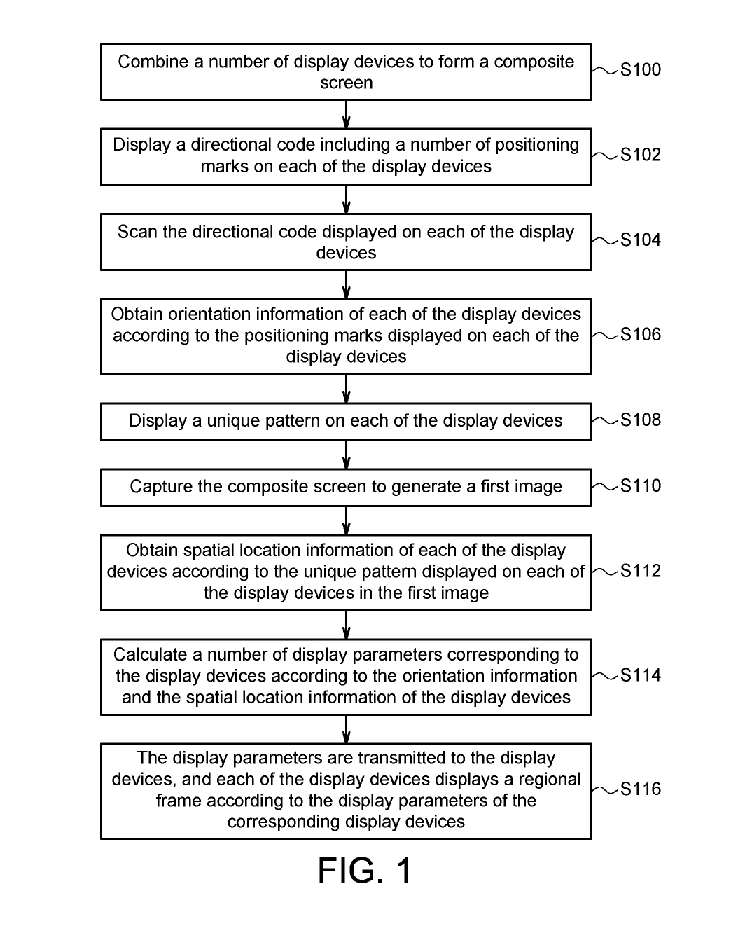

FIG. 1 is a flowchart of a method for modular display frame according to an embodiment of the present invention. The method includes the following steps. In step S100, a number of display devices are combined to form a composite screen. In step S102, a directional code including a number of positioning marks is displayed on each of the display devices. In step S104, the directional code displayed on each of the display devices is scanned. In step S106, orientation information of each of the display devices is obtained according to the positioning marks displayed on each of the display devices. In step S108, a unique pattern is displayed on each of the display devices. In step S110, the composite screen is captured to generate a first image. In step S112, spatial location information of each of the display devices is obtained according to the unique pattern displayed on each of the display devices in the first image. In step S114, a number of display parameters corresponding to the display devices are calculated according to the orientation information and the spatial location information of the display devices. In step S116, the display parameters are transmitted to the display devices. Each display device displays a regional frame according to the display parameters of the corresponding display device.

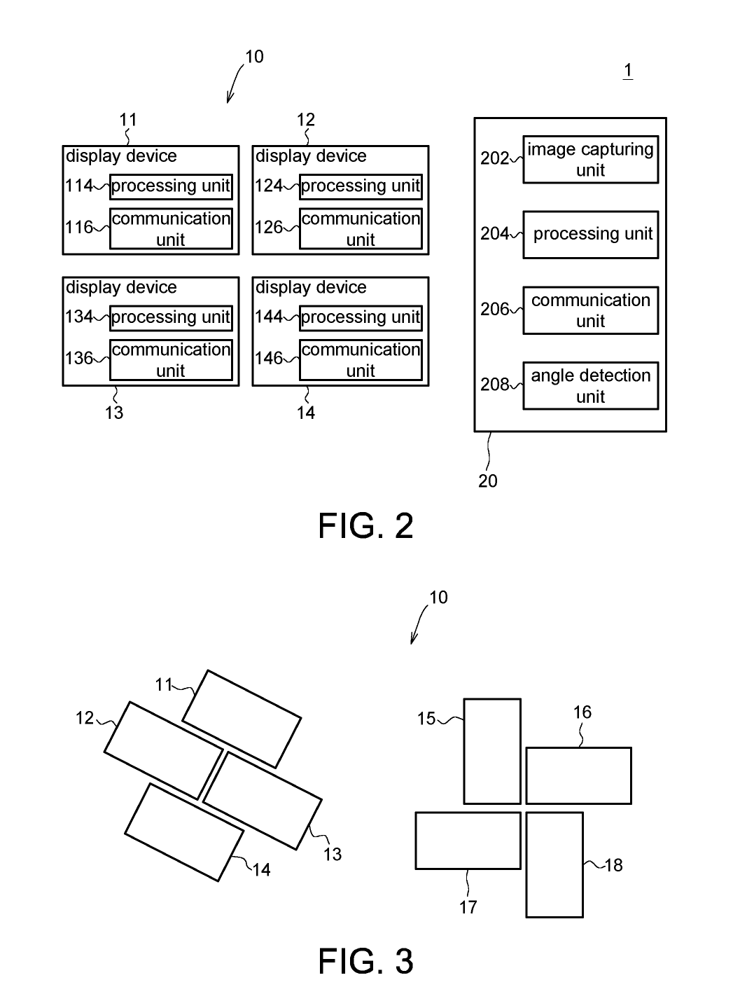

To describe the steps of the method illustrated in FIG. 1 more clearly, FIG. 2 illustrating a system for modular display frame according to an embodiment of the present invention is further provided. The system for modular display frame 1 includes a number of display devices 11˜14 and an electronic device 20. The display devices 11˜14 are combined to form a composite screen 10. Each of the display devices 11˜14 can be implemented by, for example, a liquid crystal display (LCD) or an organic light emitting diode (OLED), and the sizes of the display devices 11˜14 are not subjected to specific restrictions. For example, the display devices 11˜14 can be 40-inch-above panels, ordinary 20-inch computer screens or 5-inch mobile phone screens. The display devices 11˜14 can have different sizes and shapes. The display device 11 may include a processing unit 114 (for example, a microprocessor) and a communication unit 116. The communication unit 116 can be used for communicating with the electronic device 20 and/or other display device 12˜14 through signal transmission. Likewise, the display devices 12˜14 may also include respective processing units and communication units. The composite screen 10 is formed by display devices 11˜14 and can display one image using the display devices 11˜14 together. The number of display devices as illustrated in FIG. 3 is exemplified by four. However, the system for modular display frame 1 can combine more than four display devices or less than four display devices to form the composite screen 10 (step S100).

During a scanning stage, each of the display devices 11˜14 displays a directional code including a number of positioning marks (step S102). The directional code has directionality. That is, when the display device rotates, the directional code rotates accordingly. In an embodiment, orientation information of the display device can be obtained according to the positioning marks of the directional code.

In a capturing stage, each of the display devices 11˜14 can display a unique pattern in addition to the directional code (step S108). The patterns displayed on the display devices are different. Therefore, after the display devices 11˜14 are captured, the display devices 11˜14 can be recognized by using an image processing method. Detailed operations are disclosed below.

The electronic device 20 includes an image capturing unit 202, a processing unit 204, a communication unit 206, and an angle detection unit 208. The image capturing unit 202, the processing unit 204, the communication unit 206, and the angle detection unit 208 can be implemented by hardware circuits. For example, the image capturing unit 202 may include a camera lens and an image sensor, for example, a CMOS or a CCD image sensing element, and is capable of capturing images. The processing unit 204, which can be implemented by an ordinary microprocessor or a digital signal processor for specific application, is used for performing logic computation and/or related computation of image signal processing. The communication unit 206 can communicate with the display devices 11˜14 and can transmit related control signals for displaying image to the display devices 11˜14 through wireless communication or wired communication. For example, the communication unit 206, which can be implemented by a wireless signal transceiver such as a radio frequency (RF) circuit supporting the Wi-Fi or Bluetooth protocols, can be connected to the display devices 11˜14 through a wireless local area network (wireless LAN). The display devices 11˜14 also may include a wireless communication circuit supporting the corresponding protocols. The angle detection unit 208, for example, a g-sensor or a gyroscope, is used for detecting the rotation angle of the electronic device 20 under various states. The electronic device 20 is a mobile device having photography and computation processing functions, and can be implemented by a mobile phone, a tablet PC, a notebook computer, or a combination of a desktop computer and a camera lens. Here below, the electronic device 20 is exemplified by a mobile phone to benefit the descriptions of the drawings and related operations. However, in the present invention, the implementation of the electronic device 20 is not limited to the mobile phone.

During the scanning stage, the image capturing unit 202 scans the directional code displayed on each of the display devices 11˜14 (step S104). During the capturing stage, the image capturing unit 202 captures the composite screen 10 to generate a first image (step S110). In the flowchart of FIG. 1, steps S104 and S110 correspond to the scanning stage and the capturing stage respectively to benefit the description of subsequent operations. In practical application, steps S104 and S110 can be performed concurrently. For example, a mobile phone captures the composite screen 10 to generate the first image (step S110) and, at the same time, the mobile phone scans the directional code displayed on each of the display devices 11˜14 in the first image (step S104).

The processing unit 204 obtains orientation information of each of the display devices 11˜14 according to the positioning marks displayed on each of the display devices 11˜14 (step S106). The display frame of each of the display devices 11˜14 includes the positioning marks, and the display direction of the positioning marks is exactly the display direction of the display device. When the rotation direction of the electronic device 20 is determined by the angle detection unit 208 of the electronic device 20, the orientation information of each of the display devices 11˜14 is determined at the same time. Meanwhile, spatial location information of each of the display devices 11˜14 is obtained according to the unique pattern displayed on each of the display devices 11˜14 in the first image (step S112). After the orientation information and the spatial location information are obtained, corresponding images of the display devices 11˜14 can be obtained and whether to reverse the image of individual display device and how to divide the image near the screen edge can be determined. Thus, the processing unit 204 can calculate a number of display parameters corresponding to the display devices 11˜14 according to the orientation information and the spatial location information of display devices 11˜14 (step S114). The processing unit 204 can load in programs to perform the above computations. Taking the mobile phone for example, application programs can be installed in the mobile phone so that the processing unit 204 can perform above steps.

The communication unit 206 transmits the display parameters to the display devices 11˜14 through, for example, a wireless local area network (wireless LAN), so that each of the display devices 11˜14 displays a regional frame according to the display parameters of the corresponding display device (step S116). Each of the display devices 11˜14 respectively include a processor and an image scaler. Each of the display devices 11˜14, according to the display parameters received by the electronic device 20, knows which part of the image, for example, an area defined by coordinates, is to be displayed and displays a regional frame of the corresponding range accordingly. In implementation, the display parameters can be transmitted through different ways. For example, the electronic device 20 divides an image frame and then transmits the divided frame to the display devices 11˜14 according to, for example, the Miracast wireless display standard based on the Wi-Fi connection. Or, the display devices 11˜14 receive a single image source, and the electronic device 20 transmits block display information to each of the display devices 11˜14, which further divides the image according to the received information by themselves. Or, the display devices 11˜14 are sequentially connected in series, and the electronic device 20 transmits the division information to the first display device 11. The first display device 11, having obtained the divided frame, transmits the remaining frame information to the second display device 12, which sequentially divides the frame and obtains the divided frame. The second display device 12 transmits the remaining frame information to subsequent display devices, that is, the third display device 13 and the fourth display device 14.

According to the method and the system for modular display frame of the present invention, orientation information of the display device and the spatial location information of the display device can be obtained by using the scanning and photography functions of the electronic device to assure that the image is correctly displayed, and relevant parameters of frame division are automatically calculated by the electronic device. The user only needs to provide an image source, then the electronic device will automatically complete frame division according to the arrangement of the current composite screen. This is very convenient and fast. A number of embodiments are disclosed below to provide detailed descriptions of each step.

Regarding step S100, FIG. 3 is a schematic diagram of combining a number of display devices to form a composite screen according to an embodiment of the present invention. In the present embodiment, the composite screen 10 is formed by eight display devices 11˜18. The gap between the display devices as illustrated in the drawings is for exemplary purpose only and indicates that the composite screen is formed by a number of display devices. The display devices 11˜18 can be implemented by narrow border display panels. The display devices 11˜18 can be more tightly combined together. In the present example, the composite screen 10 displays two separate image frames. For example, the display devices 11˜14 display a first image frame (such as a film showing product functions), and the display devices 15˜18 display a second image frame (such as a frame showing a product advertisement and the purchase information).

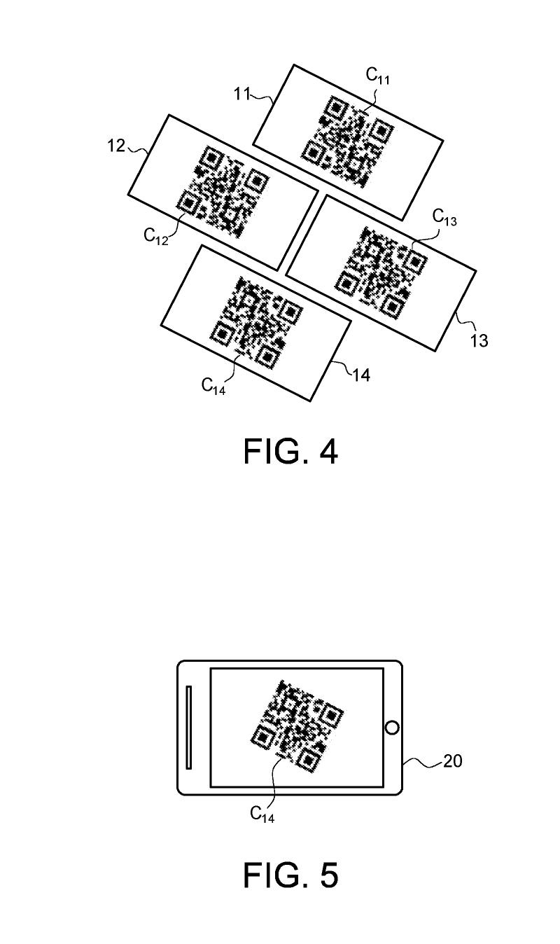

Regarding step S102, FIG. 4 is a schematic diagram of displaying a directional code on each of the display devices according to an embodiment of the present invention. FIG. 4 is exemplified by the display devices 11˜14 of FIG. 3. The display devices 11˜14 display directional codes C₁₁˜C₁₄, respectively. Each of the directional codes C₁₁˜C₁₄ can be a two-dimensional bar code having positioning marks, for example, a QR code or a Hanxin code (Chinese-sensible code). In the following description, the directional code is exemplified by the QR code. However, the directional code of the present invention is not limited to QR code. The positioning marks of the QR code are located at three corners of the QR code. Each positioning mark is double square pattern. That is, a larger square containing a smaller solid square inside. The orientation information of each of the display devices can be obtained according to the positions of the three positioning marks. The orientation information of each of the display devices 11˜14 may include an rotation angle α of each of the display devices 11˜14 The rotation angle α ranges between 0˜360°. As shown in FIG. 4, according to the directional codes C₁₁ and C₁₄ displayed on the display device 11 and display device 14 respectively, the orientation of the display device 11 is inverse to the orientation of the display device 14. That is, the rotation angle of the display device 11 and the rotation angle of the display device 14 differ by 180°. The bottom side of the display device 11 is adjacent to the bottom left of FIG. 4 (adjacent to one side of the display device 12), and the bottom side of the display device 14 is adjacent to the top right of FIG. 4 (adjacent to the other side of the display device 12).

Information can be encoded and stored in the directional codes C₁₁˜C₁₄. The information stored in the directional codes C₁₁˜C₁₄ of the display devices 11˜14 can be the identical or different from each other. In an embodiment, the directional codes C₁₁˜C₁₄ can be used for recognizing the orientation information of the display device only, and therefore the directional codes C₁₁˜C₁₄ can be identical to each other. In another embodiment, the display devices 11˜14 have unique directional codes C₁₁˜C₁₄, respectively. The information encoded and stored in each of the directional code C₁₁˜C₁₄ includes a unique device ID corresponding to each of the display devices 11˜14 to differentiate the display devices. Moreover, the device ID can be used in subsequent steps of recognizing spatial position and transmitting display parameters.

In an embodiment, the information encoded and stored in each of the directional codes C₁₁˜C₁₄ further includes at least one of a model name, a display resolution, an Internet Protocol (IP) address, a media access control (MAC) address and a group number corresponding to each of the display devices 11˜14. Examples of display resolution include 4K, Full HD, and HD. The IP address and the MAC address can be used for creating a network connection and transmitting a message through the network. The group number can be used for representing the displayed image frame. For example, the group number of the display devices 11˜14 shown in FIG. 3 can be designated by G01, and the group number of the display device 15˜18 can be designated by G02.

Regarding step S104, when the directional code is scanned by a mobile phone, the mobile phone can scan the display devices one by one or scan the display devices at the same time to obtain the information of each directional code through image processing by mobile phone. FIG. 5 is a schematic diagram of a displayed directional code after scanning the display device according to an embodiment of the present invention scanning. Let the directional code C₁₄ of FIG. 4 be taken for example. During the scanning process, the user can hold the electronic device 20 at a position in which the electronic device 20 is parallel to the horizontal ground on which the user stands when viewing the display frame to obtain the rotation angle of the directional code C₁₄ with respect to the horizontal ground.

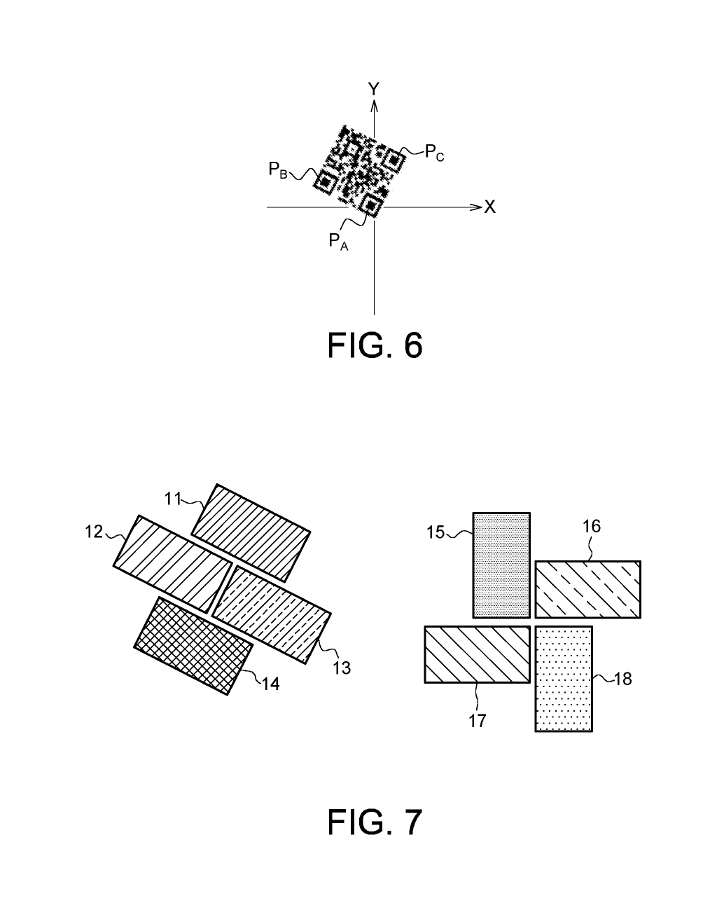

Regarding step S106, FIG. 6 is a schematic diagram of obtaining orientation information of each of the display devices according to positioning marks according to an embodiment of the present invention. The calculation of the rotation angle of the display device is exemplified by the QR code of FIG. 6. When using other kinds of directional codes having positioning marks, the rotation angle of the display device also can be calculated by similar calculation way. Each QR code includes three positioning marks P_{A}, P_{B}, and P_{C}. Before the QR code is rotated (the rotation angle is 00), the positioning marks P_{A}, P_{B}, and P_{C} are respectively located at the top-left corner, the top-right corner, and the bottom-left corner of the QR code. After the mobile phone scans the QR code, the mobile phone can recognize the positioning marks P_{A}, P_{B}, P_{C} and obtain the positioning marks P_{A}, P_{B}, P_{C}. When calculating the rotation angle of the display device, the positioning mark P_{A} can be defined as the original point of the XY plane coordinates, and the rotation angle α of the vector \vec{P_{A}P_{B}} with respect to the X axis can be obtained according to the directional vector \vec{P_{A}P_{B}} from the positioning mark P_{A} to the positioning mark P_{B}. As indicated in FIG. 6, the positioning marks P_{B} is at the second quadrant of the XY plane coordinates, and the rotation angle α is, for example, 150θ. In the example of the directional codes C₁₁, C₁₂, C₁₃, C₁₄ of FIG. 4, for the directional codes C₁₁ and C₁₂, the positioning mark P_{B} is at the fourth quadrant, so the range of the rotation angle α is between 270˜360°.

In step S104 of scanning the directional code, apart from obtaining the orientation information of the display device, the information stored in the directional code can be decoded to obtain information of the display device, for example, the device ID, the model name, the display resolution, the IP address, the MAC address, and the group number. In an embodiment, the connection information of the display devices, for example, the Wi-Fi connection information can be obtained according to the directional code displayed on each of the display devices, so that the mobile phone can communicate with the display devices through wireless communication.

Regarding step S108, FIG. 7 is a schematic diagram of displaying a unique pattern on each of the display devices according to an embodiment of the present invention. Since each of the display devices displays a different pattern, after the first image is captured, different display devices can be clearly recognized, and the position of each of the display devices can be recognized through image processing. Many implementations are available for displaying the unique pattern. As indicated in FIG. 7, each of the display devices 11˜18 displays a unique recognizable pattern whose type and shape is not subjected to specific restrictions. The pattern can occupy the full screen of the display device, so that the actual displayable range of each of the display devices 11˜18 can be obtained from the first image. One example of displaying the unique pattern by each display device is displaying the solid color frame in full-screen mode. For example, the display device 11 displays the red color in full-screen mode, the display device 12 displays the yellow color in full-screen mode, the display device 13 displays the green color in full-screen mode, and the display device 14 displays the blue color in full-screen mode. Different forms of slashes and shading shown in the display devices 11˜18 of FIG. 7 can be regarded as different solid color frames.

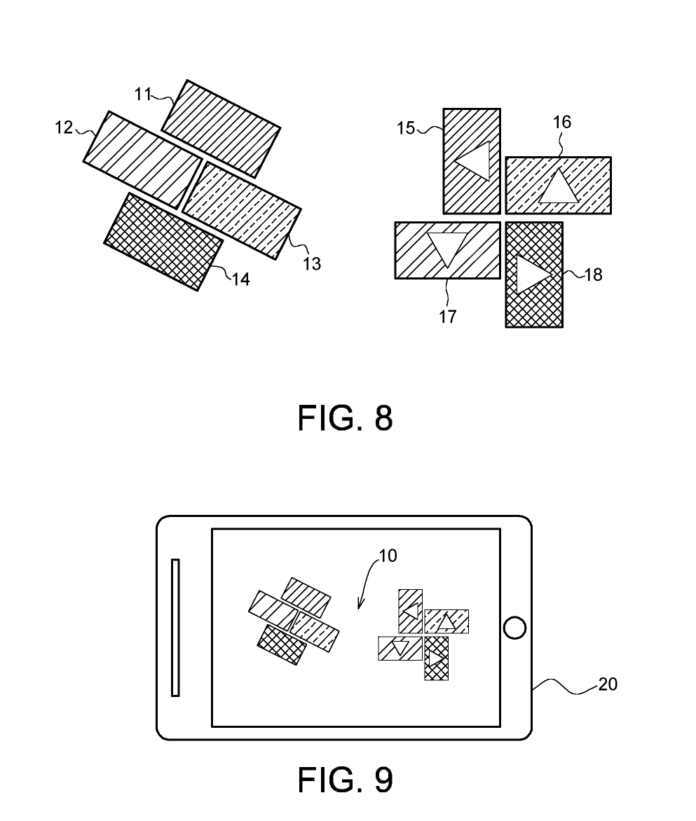

When the system for modular display frame 1 includes a large number of display devices and all frames displayed on the display devices are in solid colors, the colors may become difficult to be recognized if the colors are too similar with each other and some specific colors may be difficult to be recognized due to the ambient light source. In another embodiment, a recognizable pattern can be displayed on the solid color frame of at least one of the display devices 11˜18. The recognizable pattern is not subjected to specific types or shapes. For example, the recognizable pattern can have a simple geometric pattern. FIG. 8 is a schematic diagram of displaying a unique pattern on each of the display devices according to an embodiment of the present invention. In the present example, the display devices 11˜14 display solid color frames in full-screen mode, and each of the display devices 1518 further displays a recognizable pattern, for example, a triangle, on the solid color frame. Thus, eight display devices can be recognized through the use of four colors (the same slash and shading represents the same ground color). For example, the display device 15 and the display device 11 display the same ground color, and the display device 16 and the display device 13 display the same ground color. In an embodiment, different display devices can display different recognizable patterns, for example, a triangle, a circle, and a rectangle, so that more display devices can be recognized.

Unique patterns displayed on the display devices 11˜18 respectively can be determined by the display devices 11˜18. In an embodiment, the unique patterns displayed on the display devices 11˜18 respectively can be determined by the electronic device 20. For example, following step S104, the electronic device 20 can obtain the device ID of each of the display devices 11˜18 to know how many unique patterns are needed, so that the electronic device 20 can distribute the unique patterns to the display devices 11˜18 respectively. For example, the electronic device 20 determines the color of the solid color frame and the type of the recognizable pattern that is used. The electronic device 20 further transmits relevant information of the unique pattern to the corresponding display device 11˜18 through, for example, wireless communication.

Regarding step S110, FIG. 9 is a schematic diagram of capturing a composite screen to generate a first image according to an embodiment of the present invention. In the first image, each of the display devices 11˜18 displays a unique pattern, so that spatial location information of each of the display devices 11˜18 can be obtained (step S112). The spatial location information of each of the display devices 11˜18 includes at least one of the displayable range of each of the display devices and the coordinates of the vertexes of the corresponding display device. As mentioned in above embodiments, each of the display devices 11˜18 can display a solid color frame in full-screen mode Therefore, the displayable range of each of the display devices and the endpoints of the corresponding range can be recognized from the first image using a color block filtering technology or a similar image processing technology. Whether there are any gaps or overlaps between the display devices 11˜18 or whether the screens of the display devices 11˜18 have different sizes or shapes can be clearly determined according to the first image. Therefore, the image frames that the display devices 11˜18 need to display can be determined according to both the arrangement information of each of the display devices 11˜18 in the space and the boundary of the displayable range of each of the display devices 11˜18 obtained from the step of capturing the first image.

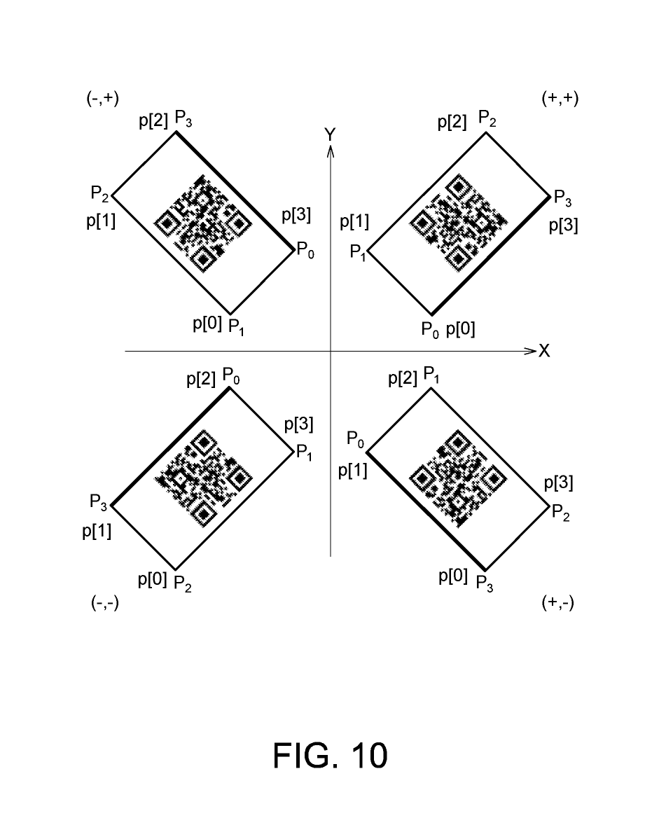

Regarding step S114, FIG. 10 is a schematic diagram of calculating display parameters according to an embodiment of the present invention. Following the step S106 of obtaining the orientation information of the display device, four original endpoints P₀˜P₃ are allocated to each of the display devices according to the orientation information. The four original endpoints P₀˜P₃ respectively correspond to the bottom-left corner, the top-left corner, the top-right corner, and the bottom-right corner of the screen. For example, the original endpoint P₀ corresponds to positioning mark P_{C}, the original endpoint P₁ corresponds to positioning mark P_{A}, the original endpoint P₂ corresponds to positioning mark P_{B}. As indicated in FIG. 10, the edge between the original endpoint P₀ and the original endpoint P₃ denotes the bottom edge of the screen (illustrated by a bold line). Following step S112 of obtaining spatial information of the display devices, the four spatial endpoints of each of the display devices can be defined as p[0]˜p[3] according to the spatial location information. The four spatial endpoints p[0]˜p[3] are arranged clockwise starting from the bottommost vertex.

As indicated in FIG. 6, the space can be divided into four quadrants according to the position of the positioning mark P_{B} on the XY plane coordinates. In different quadrants, the original endpoints P₀˜P₃ and the spatial endpoints p[0]˜p[3] have different correspondence relationships. The first quadrant (0°≦α≦90°): (P₀, P₁, P₂, P₃)=(p[0], p[1], p[2], p[3]); the second quadrant (90°≦α≦ 180°): (P₀, P₁, P₂, P₃)=(p[3], p[0], p[1], p[2]); the third quadrant (180°≦α≦270°): (P₀, P₁, P₂, P₃)=(p[2], p[3], p[0], p[1]); the fourth quadrant (270°≦α≦360°): (P₀, P₁, P₂, P₃)=(p[1], p[2], p[3], p[0]). According to the above correspondence relationships, after the first image is captured, corresponding frame contents are allocated to the display devices respectively. Thus, corresponding display parameters can be obtained and transmitted to the display devices, so that each of the display devices can display a regional frame corresponding to the display parameters.

According to the method and the system for modular display frame of the present invention, orientation information and spatial location information of the display device can be obtained through capturing by using an electronic device to assure that the image is correctly displayed on the composite screen. Besides, by calculating the rotation angle with using the directional code, the problem of the image being inversed can be effectively avoided. Therefore, when forming a composite screen, the display devices can be arbitrarily arranged and there is no need to restrict the position of the bottom edge of each of the display devices. Even the display devices have different rotation angles or are arranged upside down, the image still can be correctly displayed on the composite screen and the process for the user to arrange the display devices can be greatly simplified. The method of the present invention resolves the problem of screen rotation through the use of the directional code without installing a g-sensor inside the display device, and therefore the hardware cost is reduced.

Moreover, through the unique pattern displayed on a full screen, the display range of each of the display devices can be correctly obtained. Therefore, even the display devices have different sizes or are separated by a large distance or overlap with other, actual boundaries of the image displayed on each of the display devices still can be obtained through photography, so that corresponding display parameters can be obtained through calculation. According to the method and the system for modular display frame of the present invention, the frame division of the composite screen corresponding to the current arrangement of the composite screen can be automatically achieved by using an electronic device, therefore the user has a high degree of freedom during the arrangement of the display devices, and the user will find it simple and convenient to operate the composite screen after the arrangement of the display devices is completed.

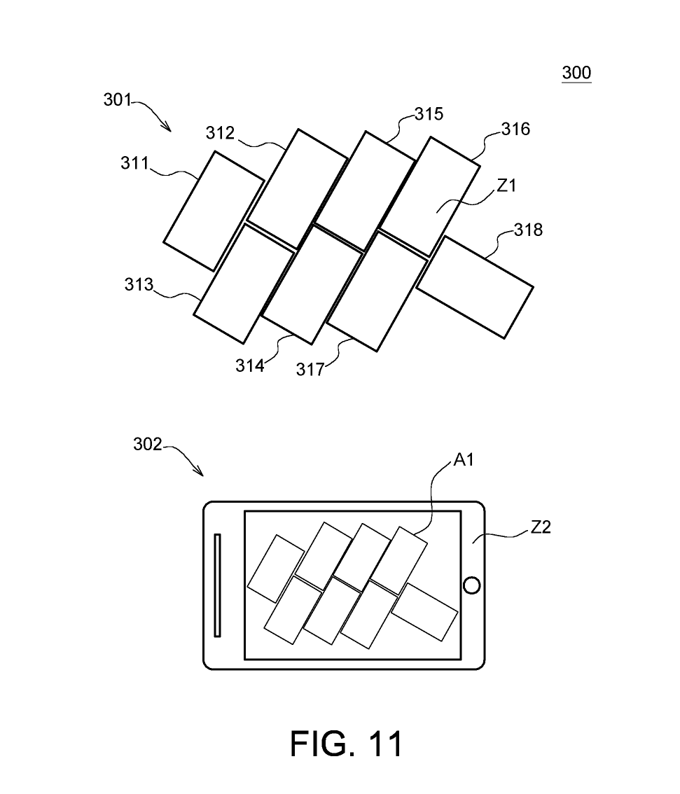

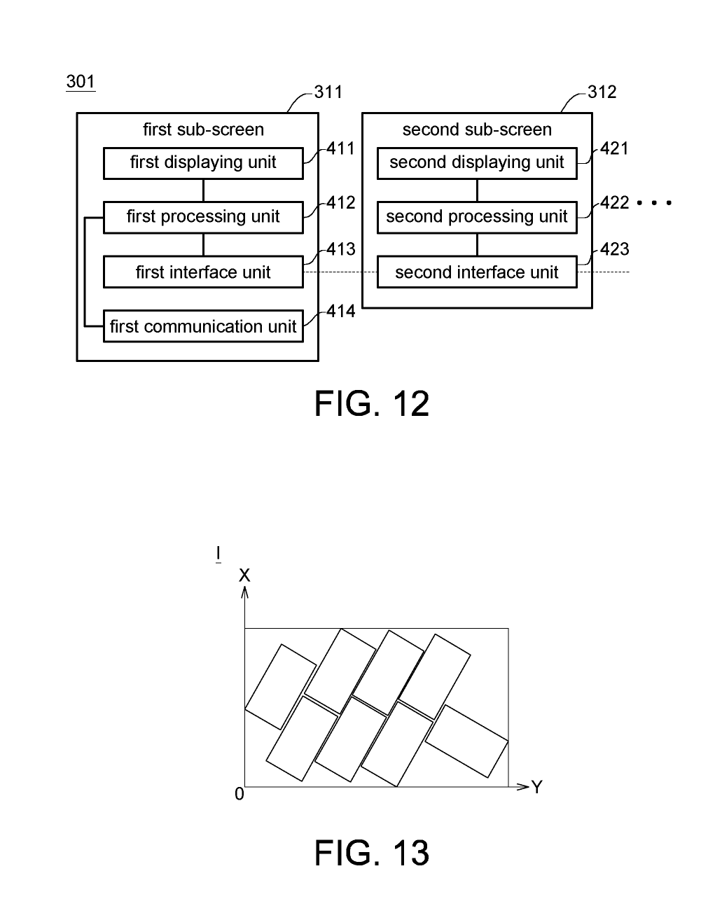

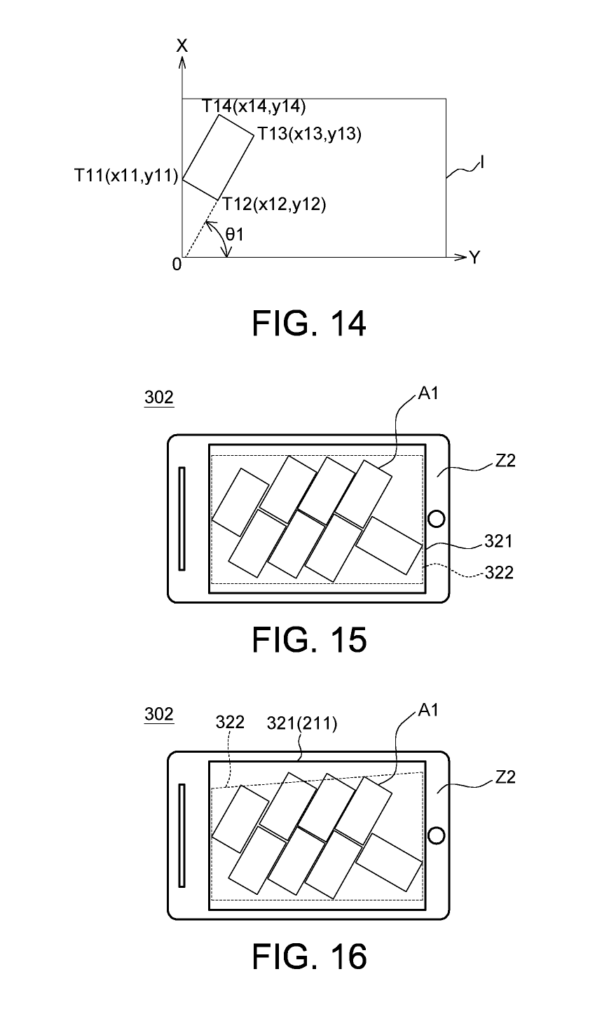

FIG. 11 to FIG. 16 shows the schematic views of a system for modular display frame according to another embodiment of the invention. FIG. 11 is a schematic view showing a photographing state of the system for modular display frame according to the embodiment of the invention. FIG. 12 is the block diagram of a sub-screen according to the embodiment of the invention. FIG. 13 is a schematic view of a first image in a predetermined coordinate system according to the embodiment of the invention. FIG. 14 is a schematic view for determining the coordinate and the angel of the first sub-screen in the first image in the predetermined coordinate system according to the embodiment of the invention. FIG. 15 is a schematic view of the image capturing unit in a predetermined state when capturing the composite screen according to the embodiment of the invention. FIG. 16 shows the actual photographing state changes with respect to the predetermined state when the image capturing unit photographs the composite screen according to the embodiment of the invention.

The system for modular display frame 300 in FIGS. 11 to 16 includes a number of sub-screens 311-318 and an image capturing unit 302. The sub-screens 311-318 include a first sub-screen 311, a second sub-screen 312, a third sub-screen 313, a fourth sub-screen 314, a fifth sub-screen 315, a sixth sub-screen 316, a seventh sub-screen 317, and an eighth sub-screen 318. The sub-screens 311-318 are pieced together sequentially to form a composite screen 301. The composite screen 301 has a first surface Z1. The composite screen 301 in this embodiment is formed by the sub-screens 311-318 which are connected in series. That is, the sub-screen 311 is connected in series to the second sub-screen 312, the second sub-screen 312 is connected in series to the third sub-screen 313, the third sub-screen 313 is connected in series to the fourth sub-screen 314, and the fourth sub-screen 314 is connected in series to the fifth sub-screen 315, the fifth sub-screen 315 is connected in series to the sixth sub-screen 316, the sixth sub-screen 316 is connected in series to the seventh sub-screen 317, and the seventh sub-screen 317 is connected in series to the eighth sub-screen 318. Thereby, when the composite screen 301 is powered on, the sub-screen 311-318 can be powered on sequentially. The image capturing unit 302 has a second surface Z2 and a window 321, and the window 321 has a border 211. The image capturing unit 302 is used to photograph the composite screen 301 to obtain a first image A1. The image capturing unit 302 sequentially obtains a number of characteristic parameters M1-M8 according to the first image A1. The sequence for obtaining the characteristic parameters M1-M8 is the same with the sequence in which the sub-screens 311-318 are pieced together to form the composite screen 301. The characteristic parameters M1-M8 corresponds to the sub-screen 311-318 one by one. The image capturing unit 302 transmits the characteristic parameters M1-M8 to the sub-screens 311-318. Each sub-screen displays a corresponding regional frame according to the corresponding characteristic parameter Mn (1≦n≦8, n is a positive integer). Alternatively, the image capturing unit 302 may transmit the first image A1 to the sub-screens 311-318, and the sub-screens 311-318 sequentially obtain the characteristic parameters M1-M8 according to the first image A1 It is emphasized that the image capturing unit 302 is intended to photograph the standard position of each sub-screen located in the first image A1 and the area of each sub-screen relative to the first image A1 can not reflect the actual ratio of the area of each sub-screen to the composite screen 301, the image capturing unit 2 should be set in a predetermined state with respect to the composite screen 1. In the predetermined state, the second surface Z2 is parallel to the first surface Z1, and the image edge of the composite screen 301 is presented adjacent to the border 211 of the window 321 or is immediately adjacent to the border 211 of the window 321 and the image of the composite screen 301 presented in the window 321 is the scaled down image of the actual image of the composite screen 301. In the practical application, the image capturing unit 302 may be a mobile communication device such as a mobile phone, a tablet, a camera, or a personal digital assistant. The number of sub-screens n according to the embodiment of the invention is selected as eight. In actual practice, the number of sub-screens is determined according to actual demand, and is not limited thereto. In this way, the modular display frame can be quickly achieved through a number of sub-screens displaying the framed to be displayed. The cost is reduced, and the operation is simple which brings more convenience to the user.

Referring FIG. 11 and FIG. 12, the first sub-screen 311 to the eighth sub-screen 318 are sequentially pieced together to be coupled to each other in order. The first sub-screen 311 includes a first displaying unit 411, a first processing unit 412, a first interface unit 413 and a first communication unit 414. The first processing unit 412 is coupled to the first displaying unit 411, the first interface unit 413, and the first communication unit 414, respectively. The second sub-screen 312 includes a second displaying unit 421, a second processing unit 422, the second interface unit 423, and the second communication unit 424. The second processing unit 422 is coupled to the second displaying unit 421, the second interface unit 423, and the second communication unit 424, respectively. When the first sub-screen 311 and the second sub-screen 312 are pieced together, the second interface unit 423 is coupled to the first interface unit 413. The third sub-screen 413 includes a third displaying unit, a third processing unit, a third interface unit, and a third communication unit. The third processing unit is coupled to the third displaying unit, the third interface unit and the third communication unit, respectively. When the second sub-screen 312 and the third sub-screen 313 are pieced together, the third interface unit is coupled to the second interface unit 423. The structure and connection relationship of the fourth sub-screen 314 to the eighth sub-screen 318 are the same as those of the second sub-screen 312 and the third sub-screen 313 (not shown). In the present embodiment, the first communication unit 414 receives a number of characteristic parameters M1-M8. The first processing unit 412 sequentially receives the characteristic parameter M1 corresponding to the first sub-screen 311 and transmits the characteristic parameters M2-M8 to the second sub-screen 312 through the first interface unit 413 and the second interface unit 423. The second processing unit 422 of the second sub-screen 312 sequentially receives the characteristic parameter M2 corresponding to the second sub-screen 312 and transmits the characteristic parameters M3-M8 to the third sub-screen 313 through the second interface unit 423 and the third interface unit, and so on. In another embodiment, the first communication unit 414 receives the first image A1, and the first processing unit 412 sequentially obtains the characteristic parameters M1-M8 according to the first image A1, and then sequentially selects the characteristic parameters M1 corresponding to the first sub-screen 311, and transmits the characteristic parameters M2-M8 to the second sub-screen 312 through the first interface unit 413 and the second interface unit 423. The second processing unit 422 of the second sub-screen 312 sequentially obtains the characteristic parameters M2 corresponding to the second sub-screen 312 and transmits the characteristic parameters M3-M8 to the third sub-screen 313 through the second interface unit 423 and the third interface unit, and so on. Alternatively, the first communication unit 414 is responsible for receiving the first image A1. The first processing unit 412 sequentially obtains the characteristic parameter M1 corresponding to the first sub-screen 311 according to the first image A1, and transmits the first image A1 to the second sub-screen 312 through the first interface unit 413 and the second interface unit 423. The second processing unit 422 of the second sub-screen 312 sequentially obtains the characteristic parameter M2 corresponding to the second sub-screen 311 according to the first image A1, and transmits the first image A1 to the third sub-screen 313 through the second interface unit 423 and the third interface unit, and so on. Of course, the first image A1 may be sequentially transmitted to the first sub-screen 311 to the eighth sub-screen 318 according to the sequence of connecting in series mentioned above, and the processing units of the first sub-screen 311 to the eighth sub-screen 318 sequentially obtain the corresponding characteristic parameter Mn according to the image A1. Preferably, the sequence in this disclosure is the sequence in which the first sub-screen 311 to the eighth sub-screen 318 are connected in series mentioned above. In the software application, the characteristic parameters M1-M8 may be sequentially set in a sequence linear table (e.g., a stack), and the characteristic parameters M1-M8 are taken out of the stack under the principle of first-in first-out, so that the characteristic parameters M1-M8 are sequentially transmitted to each of the sub-screens in order in the process of transmitting the characteristic parameters M1-M8 in the first sub-screen 311 to the eighth sub-screen 318. In practice, the first processing unit 412 has integrated application processor function and scaler board function, and the second processing unit 422 and the third processing unit are scaler board. The application processor supports Miracast standard and the image capturing unit 302 also supports the Miracast standard for implementing the video streaming sharing between the image capturing unit 302 and the composite screen 301. The scaler board can control screen scaling according to the characteristics parameter Mn. The first interface unit 413, the second interface unit 423, and the third interface unit to the eighth interface unit may be series communication interface (component object mode interface, i.e. RS232 interface), an I2C bus (Inter-IC bus) interface or a High Definition Multimedia Interface (HDMI). The first communication unit 414 may be an application performance management board of an integrated wireless communication module. Of course, each sub-screen also has a power and a backlight. The power is connected to the scaler board and the backlight, and the backlight is used for providing light source to each displaying unit. In this way, each sub-screen can cut the frame to be displayed according to the corresponding characteristic parameter Mn to obtain a corresponding regional frame, and each sub-screen scales the corresponding regional frame according to the corresponding characteristic parameter Mn and display the regional frame through respect displaying unit. That is, the first displaying unit 411 displays the regional frame which is scaled by the first sub-screen 311 according to the characteristic parameter M1, and the second displaying unit 421 displays the regional frame which is scaled by the second sub-screen 312 according to the characteristic parameter M2, and so on.

In another embodiment, when the composite screen 301 is powered to power on the sub-screen 311-318 sequentially, each sub-screen may obtain an identification information Sn (1≦n≦8, n is a positive integer) accordingly and stores the identification information Sn in the corresponding sub-screen. The image capturing unit 302 sequentially obtains the characteristic parameters M1-M8 according to the first image A1 and sequentially assigns an identification information Nn (1≦n≦8, n is a positive integer) to each characteristic parameter. The image capturing unit 302 transmits the characteristic parameters M1-M8 and the corresponding identification information N1-N8 to the sub-screen 311-318. Each sub-screen obtains corresponding characteristic parameters Mn according to corresponding identification information Nn. That is, the image capturing unit 302 transmits the characteristic parameters M1-M8 and the corresponding identification information N1-N8 to the first communication unit 414. The first communication unit 414 receives the characteristic parameters M1-M8 and the identification information N1-N8. When the first processing unit 412 judges that the identification information S1 matches the identification information N1, the first processing unit 412 selects the characteristic parameter M1 as the characteristic parameter corresponding to the first sub-screen 311 and continues to transmit the characteristic parameters M1-M8 and the corresponding identification information N1-N8 to the second sub-screen 312. When the second processing unit 422 judges that the identification information S2 matches the identification information N2, the second processing unit 422 selects the characteristic parameter M2 as the characteristic parameter corresponding to the second sub-screen 312, and continues to transmit the characteristic parameters M1-M8 and the corresponding identification information N1-N8 to the third sub-screen 313, and so on. By doing so, each sub-screen can get the corresponding characteristic parameter. In another embodiment, the sub-screens 311-318 sequentially obtain the characteristic parameters M1-M8 according to the first image A1 and sequentially assign an identification information Nn (1≦n≦8, n is a positive integer) to each characteristic parameter. Each sub-screen obtains the corresponding characteristic parameter Mn according to the corresponding identification information Nn. That is, the image capturing unit 302 transmits the first image A1 to the first communication unit 414, and the first communication unit 414 receives the first image A1. The first processing unit 412 sequentially obtains the characteristic parameters M1-M8 and the identification information N1-N8 according to the first image A1. When the first processing unit 412 judges that the identification information S1 matches with the identification information N1 the first processing unit 412 selects the characteristic parameter M1 as the characteristic parameter corresponding to the first sub-screen 311 and continues to transmit the characteristic parameters M1-M8 and the corresponding identification information N1-N8 to the second sub-screen 312. When the second processing unit 422 judges that the identification information S2 matches the identification information N2, the second processing unit 422 selects the characteristic parameter M2 as the characteristic parameter corresponding to the second sub-screen 312, and continues to transmit the parameters M1-M8 and the corresponding identification information N1-N8 to the third sub-screen, and so on. By doing so, each sub-screen can obtain the corresponding characteristic parameter. Alternatively, the first image A1 may be transmitted to the first sub-screen 311 to the eighth sub-screen 318, and the respective processing units of the first sub-screen 311 to the eighth sub-screen 318 obtain the characteristic parameter M1-M8 and identification information N1-N8 according to the first image A1. The respective processing units of the first sub-screen 311 to the eighth sub-screen 318 determine the corresponding characteristic parameter according to whether the respective identification information Sn matches the identification information Nn. In this way, it is possible to quickly realize the exact corresponding between the sub-screens and the characteristic parameters, the use of the hardware device is reduced, and thereby the cost is lowered. Alternatively; each sub-screen may store an identification information Sn (1≦n≦8, n is a positive integer) in advance. When the power is applied, each sub-screen displays the pre-stored identification information Sn on the respective displaying unit. That is, the first sub-screen 311 displays the identification information S1 on the first display unit 411, and the second sub-screen 312 displays the identification information S2 on the second display unit 421, and so on. When the image capturing unit 302 takes the picture of the composite screen 301, the first image A1 having the respective identification information Sn can be obtained at the same time, the characteristic parameters M1-M8 corresponding to each identification information Sn are obtained, and each characteristic parameter is corresponded to one identification information Nn (i.e. the above-mentioned identification information Sn) (1≦n≦8, n is a positive integer). The image capturing unit 302 transmits the characteristic parameters M1-M8 and the corresponding identification information N1-N8 to the sub-screens 311-318 and each sub-screen obtains the corresponding characteristic parameter Mn according to the corresponding identification information Nn. In this way, when irregular piecing together is resulted for the change in the structure during the process of piecing the sub-screens, the problem of identifying the characteristic parameters of each sub-screen can be easily resolved.

Preferably, referring to FIG. 13 and FIG. 14, the first image A1 includes the images of the captured first sub-screen 311 to the eighth sub-screen 318. The area ratio of each sub-screen on the first surface Z1 is the same with the area ratio of the image of each sub-screen in the first image A1. In the actual operation, the first image A1 may be formed by the image which is the image generated by capturing the composite screen 301 by the image capturing unit 302 and then being processed by noise reduction and cutting. In the present embodiment, in order to obtain the characteristic parameter Mn, the adjacent edges of the first image A1 may be taken as the x-axis and the y-axis, respectively, to form a plane coordinate system x-y whose origin o is at the lower-left corner of the first image A1. The embodiment is not limit thereto. The characteristic parameter Mn includes the coordinate information Tn and the angle information 81. The sub-screens 311-318 are square screens, rectangular screens, or other polygonal screens. The coordinate information Tn (1≦n≦8, n is a positive integer) includes vertex coordinates of the polygonal screens. In this embodiment, the sub-screens 311-318 are all rectangular screens. The coordinate information Tn (1≦n≦8, n is a positive integer) includes a first vertex coordinate Tn1 (xn1, yn1), a second vertex coordinate Tn2 (xn2, y2n), a third vertex coordinates Tn3 (xn3, yn3), and a fourth vertex coordinates Tn4 (xn4, yn4). For example, the coordinate information T1 of the first sub-screen 311 includes the first vertex coordinates T11 (x11, y11), the second vertex coordinates T12 (x12, y12), the third vertex coordinates T13 (x13, y13), and the fourth vertex coordinates T14 (x14, y14). The angle information 81 may be the angle between the longitudinal direction of the first sub-screen 311 and the y-axis direction. Through the coordinate information Tn and the angle information 81 included in the characteristic parameter Mn, the area and corresponding location of the frame to be displayed for each sub-screen can be obtained.

Referring to FIG. 15 and FIG. 16, as mentioned above, in order to make the image capturing unit 302 to generate the image which is capable of analyzing the standard position of each sub-screen located in the first image A1 and the area ratio of each sub-screen with respect to the first image A1 can reflect the actual area ratio of each sub-screen, the image capturing unit 302 should be set to be in the predetermined state with respect to the composite screen 301 in which the second surface Z2 is parallel to the first surface Z1. At this situation, the image edges of the composite screen 301 in the window 321 are adjacent to or immediately adjacent to the border 211 of the window 321. The image of the composite screen 301 in the window 321 is the scaled down image of the actual image of the composite screen 301. That is, comparing to other photograph state, the image of the composite screen 301 presented in the window 321 under the predetermined state is closer to the actual presentation of the actual image of the composite screen 301. Referring to FIG. 15, when photographing, the image capturing unit 302 may be set at a predetermined position with respect to the composite screen 301. The predetermined position may be determined by a specific position on the composite screen 301. For example, the image capturing unit 302 may be located upright (or horizontally) at the specific position or be spaced from the specific position by a predetermined distance. A correction mark 322 may be present at the window 321. In the present embodiment, the correction mark 322 may be a line frame. When the image capturing unit 302 is set in the predetermined state with respect to the composite screen 301, the space between the edges of the line frame and the edges of the border 211 of the window 321 is equal, or the shape of the line frame is a predetermined shape (e.g., rectangular). Under the situation that the location of the image capturing unit 302 changes with respect to the composite screen 301, if the image of the composite screen 301 in the window 21 is still in the above-mentioned predetermined state after the image capturing unit 302 leaves the predetermined position, the space between the correction mark 322 and the border 211 does not change or the shape of the correction mark 322 is still the predetermined shape. If the actual captured image of the composite screen 301 in the window 321 deviates from the predetermined state after the image capturing unit 302 leaves the predetermined position, the space between the correction mark 322 and the border 211 is changed or the shape of the correction mark 322 is no longer the above-mentioned predetermined shape. The predetermined state can be gradually restored by adjusting the correction mark 322. In the actual operation, the image capturing unit 302 may be equipped with a g-sensor. When the image capturing unit 302 deviates from the predetermined state with respect to the composite screen 301, the change of the angle is recorded and the correction mark 22 simultaneously have the changes mentioned above. In this way, the problems of possible skewing, hand-shaking, too large or too small captured image which should be adjusted to the predetermined state is effectively resolved.

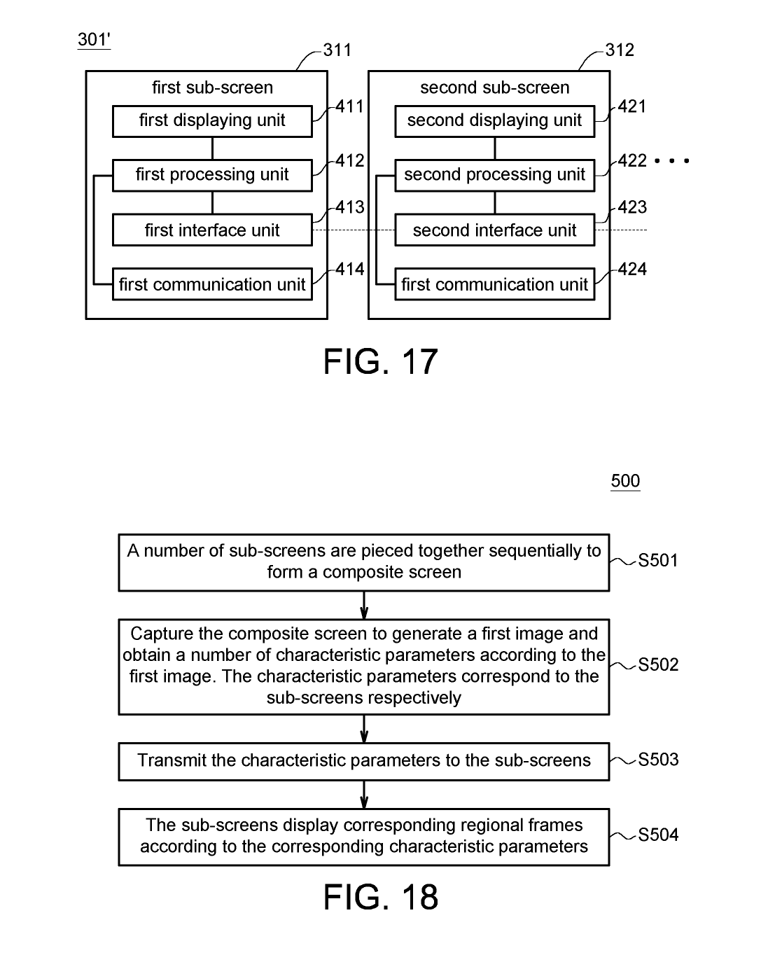

Referring to FIG. 17, a system of modular display frame according to another embodiment of the present invention is shown. The difference between the above embodiments is that the system of modular display frame 300 includes a composite screen 301′. Except that the first sub-screen 311 includes a first communication unit 414, the second sub-screen 312 also includes a second communication unit 423, and the third sub-screen 313 includes a third communication unit, and so on. Each sub-screen includes a communication unit having the same function as the first communication unit 414. The image capturing unit 302 respectively trans s the characteristic parameters M1-M8 and the corresponding identification information N1-N8 to the first communication unit 414, the second communication unit 424, the third communication unit, . . . and the eighth communication unit. The first communication unit 414, the second communication unit 424, the third communication unit, . . . and the eighth communication unit receive the characteristic parameters M1-M8 and the corresponding identification information N1-N8, respectively. The processing unit of each sub-screen selects the characteristic parameter according to the above-described way of selecting the characteristic parameter, which will not be repeated here.

Referring to FIG. 18, a method for modular display frame according to an embodiment of the present invention is shown. The method for modular display frame 500 can be applied in the system for modular display frame mentioned above, and the related components, structural relationships and the labels are the same as the embodiment described above. The method for modular display frame includes the following steps:

S101: The sub-screens are pieced together sequentially to form a composite screen, and then step S102 is entered;

S102: the composite screen 301 is captured to generate a first image A1, a number of characteristic parameters M1-M8 are obtained according to the first image A1, the characteristic parameters M1-M8 correspond to the sub-screens 311-318 one by one, and then step S103 is entered;

S103: the characteristic parameters M1-M8 are transmitted to the sub-screens 311-318, each of the sub-screens displays corresponding regional frames according to the corresponding characteristic parameter Mn.

In the above-mentioned steps, the characteristic parameter Mn includes the coordinate information Tn and the angle information θ1. The step of capturing the composite screen 301 also includes the steps of presenting a correction mark and when the actual capturing state changes with respect to the predetermined state, the actual capturing state can be corrected to the predetermined state by adjusting the correction mark. The details can be referred to the embodiment described above, and will not be repeated here. In this way, the demand of convenience for the user can be satisfied, the corresponding of the sub-screens and the characteristic parameters can be realized rapidly, it is achieved that the frame to be displayed is cut to blocks and displayed, and the cost is reduced.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for modular display frame, comprising:
combining a plurality of display device to form a composite screen;
displaying a directional code on each of the display devices, wherein the directional code comprises a plurality of positioning marks;
scanning the directional code displayed on each of the display devices;
obtaining orientation information of each of the display devices according to the positioning marks displayed on each of the display devices;
displaying a unique pattern on each of the display devices;
capturing the composite screen to generate a first image;
obtaining spatial location information of each of the display devices according to the unique pattern displayed on each of the display devices in the first image;
calculating a plurality of display parameters corresponding to the display devices according to the orientation information of and the spatial location information of the display devices; and
transmitting the display parameters to the display devices, wherein each of the display devices displays a regional frame according to the display parameters of the corresponding display device.

2. The method according to claim 1, wherein the information encoded and stored in the directional code displayed on each of the display devices comprises a unique device ID of the corresponding display device.

3. The method according to claim 2, wherein the information encoded and stored in the directional code further comprises at least one of a model name, a display resolution, an Internet Protocol (IP) address, a media access control (MAC) address, and a group number of the corresponding display device.

4. The method according to claim 1, further comprising:
determining the unique pattern displayed on each of the display devices, and transmitting relevant information of the determined unique pattern of the corresponding display device.

5. The method according to claim 1, wherein the step of displaying the unique pattern on each of the display devices step comprises:
displaying a solid color frame on each of the display devices in full-screen mode; and
displaying a recognizable pattern on the solid color frame of at least one of the display devices.

6. The method according to claim 1, wherein the spatial location information of each of the display devices comprises at least one of the displayable range of the corresponding display device and the coordinates of the vertexes of the corresponding display device.

7. A system for modular display frame, comprising:
a plurality of display devices combined to form a composite screen, wherein during a scanning stage, each of the display devices displays a directional code comprising a plurality of positioning marks, and during a capturing stage, each of the display devices displays a unique pattern; and
an electronic device, comprising:
an image capturing unit, wherein during the scanning stage, the image capturing unit scans the directional code displayed on each of the display devices, and during the capturing stage, the image capturing unit captures the composite screen to generate a first image;
a processing unit, for obtaining orientation information of each of the display devices according to the positioning marks displayed on each of the display devices, obtaining spatial location information of each of the display devices according to the unique pattern displayed on each of the display devices in the first image, and calculating a plurality of display parameters of the corresponding display device according to the orientation information and the spatial location information of the display devices; and
a communication unit, for transmitting the display parameters to the display devices, so that each of the display devices displays a regional frame according to the display parameters of the corresponding display device.

8. The system according to claim 7, wherein the information encoded and stored in the directional code displayed on each of the display devices comprises a unique device ID of the corresponding display device.

9. The system according to claim 7, wherein the processing unit is further configured to determine the unique patterns, each of the unique patterns is displayed on the corresponding display device, and the communication unit transmits relevant information of the determined unique patterns to the corresponding display devices.

10. The system according to claim 7, wherein in the capturing stage, each of the display devices displays a solid color frame in full-screen mode, and at least one of the display devices displays a recognizable pattern on the corresponding solid color frame.

11. A system for modular display frame, comprising:
a plurality of sub-screens pieced together sequentially to form a composite screen;
an image capturing unit, for capturing the composite screen to generate a first image, wherein the image capturing unit obtains a plurality of characteristic parameters according to the first image, the characteristic parameters correspond to the sub-screens respectively;
wherein the image capturing unit transmits the characteristic parameters to the sub-screens, and each of the sub-screens displays corresponding regional frames according to the corresponding characteristic parameter.

12. The system according to claim 11, wherein the characteristic parameters comprises coordinate information and angle information.

13. The system according to claim 11, wherein the image capturing unit sequentially obtains the characteristic parameters according to the first image and sequentially assigns an identification information to each of the characteristic parameters, the image capturing unit transmits the characteristic parameters and the corresponding identification information to the sub-screens, the sub-screen obtain the corresponding characteristic parameters according to the corresponding identification information.

14. The system according to claim 13, wherein the sub-screens comprise a first sub-screen and a second sub-screen, the first sub-screen and the second sub-screen are pieced together;
the first sub-screen comprises a first communication unit and a first processing unit, the first communication unit is coupled to the first processing unit; and
the second sub-screen comprises a second communication unit and a second processing unit, the second communication unit is coupled to the second processing unit;
wherein the first communication unit and the second communication unit receive the characteristic parameters and the identification information respectively, and the first processing unit obtains the characteristic parameter corresponding to the first sub-screen according to the identification information, and the second processing unit obtains the characteristic parameter corresponding to the second sub-screen according to the identification information.

15. The system according to claim 13, wherein the sub-screens comprise a first sub-screen and at least one second sub-screen, the first sub-screen and the at least one second sub-screen are sequentially pieced together and are coupled to each other in order;
the first sub-screen comprises a first communication unit and a first processing unit, the first communication unit is coupled to the first processing unit, the first communication unit receives the characteristic parameters and the identification information, the processing unit obtains the characteristic parameter corresponding to the first sub-screen according to the identification information, the first sub-screen transmits the characteristic parameters and the identification information to the at least one second sub-screen.

16. The system according to claim 11, wherein the sub-screens comprises first sub-screen and a second sub-screen, the first sub-screen and the second sub-screen are pieced together;
the first sub-screen comprises a first communication unit and a first processing unit, the first communication unit is coupled to the first processing unit;
the second sub-screen comprises a second communication unit and a second processing unit, the second communication unit is coupled to the second processing unit;
wherein the first communication unit and the second communication unit receive the characteristic parameters respectively, the first processing unit obtains the characteristic parameter corresponding to the first sub-screen, and the second processing unit obtains the characteristic parameter corresponding to the second sub-screen.

17. The system according to claim 11, wherein the sub-screens comprise a first sub-screen and at least one second sub-screen, the first sub-screen and the at least one second sub-screen are sequentially pieced together to be coupled to each other in order;
the first sub-screen comprises a first communication unit and a first processing unit, the first communication unit is coupled to the first processing unit, the first communication unit receives the characteristic parameters, the first processing unit obtains the characteristic parameter corresponding to the first sub-screen, the first sub-screen transmits the characteristic parameters or remaining characteristic parameters to the at least one second sub-screen.

18. The system according to claim 11, wherein the image capturing unit has a window, the image capturing unit firstly is in a predetermined state with respect to the composite screen when the image capturing unit captures the composite screen, a correction mark is presented at the window, and when the relative position between the image capturing unit and the composite screen change, the image capturing unit is restored to the predetermined state by adjusting the correction mark.

19. The system according to claim 11, wherein each of the sub-screens cuts a frame to be displayed according to the corresponding characteristic parameter to obtain the corresponding regional frame, and then each of the sub-screens scales the corresponding regional frame according to the corresponding characteristic parameter and displays the corresponding regional frame.

20. The system according to claim 11, wherein each of the sub-screens displays a directional code respectively, the directional code comprises a plurality of positioning marks;
the directional code displayed on each of the sub-screens is scanned;
the orientation information of each of the sub-screens is obtained according to the positioning marks displayed on each of the sub-screens;
a unique pattern is displayed on each of the sub-screens;
spatial location information of each of the sub-screens is obtained according to the unique pattern displayed on each of the sub-screens in the first image;
the characteristic parameters corresponding to the sub-screens are calculated according to the orientation information and the spatial location information of the sub-screens.
